(19) United States
(12) Patent Application Publication
(10) Pub. No.: US 2007/0140190 A1
(43) Pub. Date: Jun. 21, 2007

(54) Method and system for uplink scheduling in an orthogonal frequency division multiple access network

(75) Inventors: Cornelius Van Rensburg, Dallas, TX (US); Yinong Ding, Plano, TX (US); Farooq Khan, Allen, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/314,540

(22) Filed: Dec. 21, 2005

(51) Int. Cl. H04Q 7/24

(52) U.S. Cl. 370/338; 370/252

(57) ABSTRACT

A method of uplink scheduling in an Orthogonal Frequency Division Multiple Access network is provided. The method includes classifying each of a plurality of users as one of an exploration user and a utilization user. The users are then scheduled based on the classification of each of the users as one of an exploration user and a utilization user.

### TECHNICAL FIELD OF THE INVENTION

The present disclosure relates generally to wireless communications and, more specifically, to a method and system for uplink scheduling in an Orthogonal Frequency Division Multiple Access (OFDMA) network.

### BACKGROUND OF THE INVENTION

In OFDMA networks, the bandwidth used for communication is divided into sub-channels. Typically, a base station can only determine the channel quality for the sub-channel on which a particular mobile station is transmitting because the mobile station only transmits its pilot signal on that sub-channel. To determine channel quality for other sub-channels, the base station may prompt the mobile station to either transmit a channel-sounding signal on another sub-channel or jump to other sub-channels and provide pilot signals on those sub-channels. However, this approach wastes bandwidth. Furthermore, because the base station does not know the channel quality for the sub-channels to which the mobile station will jump before the mobile station jumps, the mobile station is given the safest mode of communication, which is the least spectrally efficient. Therefore, there is a need in the art for a more spectrally efficient method of uplink scheduling that allows the mobile station to transmit on an optimum sub-channel.

### SUMMARY OF THE INVENTION

A method for uplink scheduling in an Orthogonal Frequency Division Multiple Access (OFDMA) network is provided. According to an advantageous embodiment of the present disclosure, the method includes classifying each of a plurality of users as one of an exploration user and a utilization user. The users are then scheduled based on the classification of each of the users as one of an exploration user and a utilization user.

According to another embodiment of the present disclosure, a method for uplink scheduling in an OFDMA network is provided that includes classifying each of a plurality of users as one of an exploration user and a utilization user. Each of the users is assigned a number of slots based on a traffic type for each of the users. The users are scheduled the assigned number of slots based on the classification of each of the users as one of an exploration user and a utilization user and based on the traffic type for each of the users.

According to yet another embodiment of the present disclosure, a base station capable of providing uplink scheduling in an OFDM network is provided that includes a classifier, a selector and a slot allocator. The classifier is operable to classify each of a plurality of users as one of an exploration user and a utilization user. The selector is coupled to the classifier and is operable to select at least a portion of the users for slot allocation based on a traffic type for each of the users and to assign a number of slots to each of the selected users. The slot allocator is coupled to the classifier and to the selector. The slot allocator is operable to schedule the users based on the classification of each of the users as one of an exploration user and a utilization user and based on the traffic type for each of the users.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the term “each” means every one of at least a subset of the identified items; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary Orthogonal Frequency Division Multiplexing (OFDM) wireless network that is capable of providing uplink scheduling according to an embodiment of the present disclosure;

FIG. 2 illustrates an exemplary base station that is capable of uplink scheduling according to an embodiment of the present disclosure;

FIG. 3 illustrates an example of uplink scheduling provided by the base station of FIG. 2 according to an embodiment of the present disclosure; and

FIG. 4 is a flow diagram illustrating a method for uplink scheduling in the base station of FIG. 2 according to an embodiment of the present disclosure.

### DETAILED DESCRIPTION OF THE INVENTION

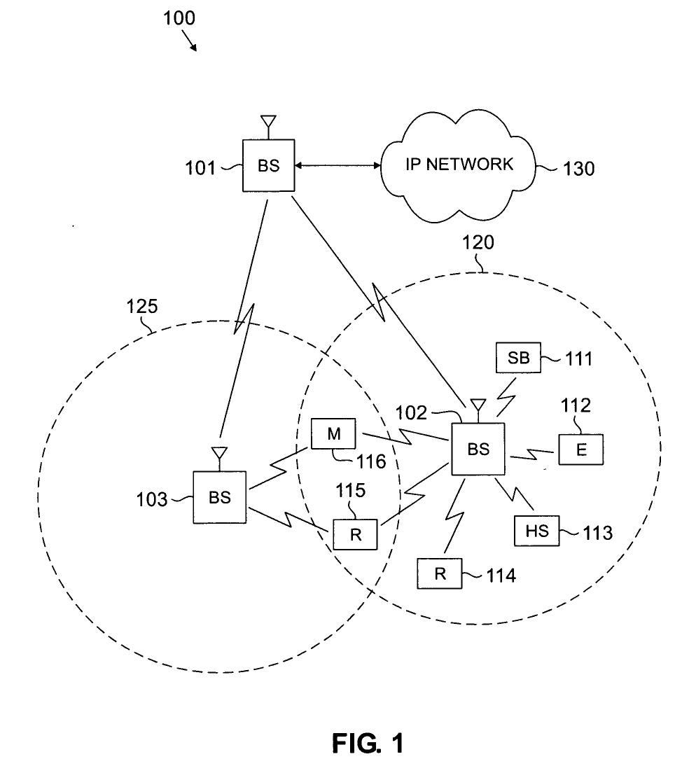

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

FIG. 1 illustrates an exemplary Orthogonal Frequency Division Multiplexing wireless network 100 that is capable of providing uplink scheduling according to one embodiment of the present disclosure. In the illustrated embodiment, wireless network 100 includes base station (BS) 101, base station (BS) 102, and base station (BS) 103. Base station 101 communicates with base station 102 and base station 103. Base station 101 also communicates with Internet protocol (IP) network 130, such as the Internet, a proprietary IP network, or other data network.

Base station 102 provides wireless broadband access to network 130, via base station 101, to a first plurality of subscriber stations within coverage area 120 of base station 102. The first plurality of subscriber stations includes subscriber station (SS) 111, subscriber station (SS) 112, subscriber station (SS) 113, subscriber station (SS) 114, subscriber station (SS) 115 and subscriber station (SS) 116. In an exemplary embodiment, SS 111 may be located in a small business (SB), SS 112 may be located in an enterprise (E), SS 113 may be located in a WiFi hotspot (HS), SS 114 may be located in a first residence, SS 115 may be located in a second residence, and SS 116 may be a mobile (M) device.

Base station 103 provides wireless broadband access to network 130, via base station 101, to a second plurality of subscriber stations within coverage area 125 of base station 103. The second plurality of subscriber stations includes subscriber station 115 and subscriber station 116.

In other embodiments, base station 101 may be in communication with either fewer or more base stations. Furthermore, while only six subscriber stations are shown in FIG. 1, it is understood that wireless network 100 may provide wireless broadband access to more than six subscriber stations. It is noted that subscriber station 115 and subscriber station 116 are on the edge of both coverage area 120 and coverage area 125. Subscriber station 115 and subscriber station 116 each communicate with both base station 102 and base station 103 and may be said to be operating in soft handoff, as known to those of skill in the art.

In an exemplary embodiment, base stations 101-103 may communicate with each other and with subscriber stations 111-116 using an IEEE-802.16 or IEEE-802.20 wireless metropolitan area network standard, such as, for example, an IEEE-802.16d or IEEE-802.16e standard. In another embodiment, however, a different wireless protocol may be employed, such as, for example, a HIPERMAN wireless metropolitan area network standard. Base station 101 may communicate through direct line-of-sight with base station 102 and base station 103. Base station 102 and base station 103 may each communicate through non-line-of-sight with subscriber stations 111-116 using OFDM and/or OFDMA techniques.

Base station 102 may provide a T1 level service to subscriber station 112 associated with the enterprise and a fractional T1 level service to subscriber station 111 associated with the small business. Base station 102 may provide wireless backhaul for subscriber station 113 associated with the WiFi hotspot, which may be located in an airport, café, hotel, or college campus. Base station 102 may provide digital subscriber line (DSL) level service to subscriber stations 114, 115 and 116.

Subscriber stations 111-116 may use the broadband access to network 130 to access voice, data, video, video teleconferencing, and/or other broadband services. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer, a laptop computer, a gateway, or another device.

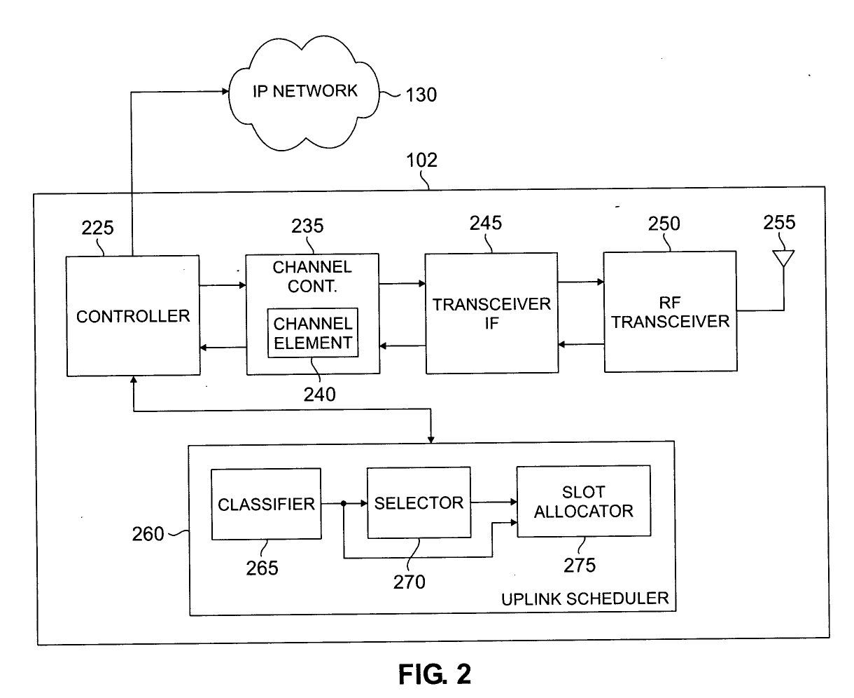

In accordance with an embodiment of the present disclosure, each base station 101-103 is operable to provide uplink scheduling for the subscriber stations 111-116 based on a traffic type and a classification for each of the subscriber stations 111-116 and based on channel quality for the sub-channels on which the subscriber stations 111-116 may communicate, as described in more detail below in connection with FIGS. 2-4. Thus, each base station 101-103 is operable to schedule the uplink communication for subscriber stations 111-116 in a spectrally efficient manner that takes into consideration which sub-channel is optimum for communicating with each subscriber station 111-116.

The classification of each subscriber station 111-116 is based in part on a user status for the subscriber station 111-116. For one embodiment, each subscriber station 111-116 may comprise a user status of dormant, initially active, or continuing active. A subscriber station 111-116 with a user status of dormant is not currently in active communication with a base station 101-103. It will be understood that the subscriber station 111-116 with a user status of dormant may be communicating control information with a base station 101-103; however, the subscriber station 111-116 is not currently sending communication data to be forwarded by base station 101-103 to another communication device. A subscriber station 111-116 with a user status of initially active has just begun active communication with a base station 101-103, which has not yet determined an optimum sub-channel for communication with the subscriber station 111-116. A subscriber station 111-116 with a user status of continuing active is currently in active communication with a base station 101-103, which has determined an optimum sub-channel for communication with the subscriber station 111-116 at some point during the current communication session.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Also, the coverage areas associated with base stations are not constant over time and may be dynamic (expanding or contracting or changing shape) based on changing transmission power levels of the base station and/or the subscriber stations, weather conditions, and other factors. In an embodiment, the radius of the coverage areas of the base stations, for example, coverage areas 120 and 125 of base stations 102 and 103, may extend in the range from about 2 kilometers to about fifty kilometers from the base stations.

As is well known in the art, a base station, such as base station 101, 102, or 103, may employ directional antennas to support a plurality of sectors within the coverage area. In FIG. 1, base stations 102 and 103 are depicted approximately in the center of coverage areas 120 and 125, respectively, In other embodiments, the use of directional antennas may locate the base station near the edge of the coverage area, for example, at the point of a cone-shaped or pear-shaped coverage area.

The connection to network 130 from base station 101 may comprise a broadband connection, for example, a fiber optic line, to servers located in a central office or another operating company point-of-presence. The servers may provide communication to an Internet gateway for internet protocol-based communications and to a public switched telephone network gateway for voice-based communications. The servers, Internet gateway, and public switched telephone network gateway are not shown in FIG. 1. In another embodiment, the connection to network 130 may be provided by different network nodes and equipment.

FIG. 2 illustrates exemplary base station 102 in greater detail according to one embodiment of the present disclosure. Base station 102 is illustrated by way of example only. However, it will be understood that the components illustrated and described with respect to base station 102 are also part of base stations 101 and 103. In one embodiment, base station 102 comprises controller 225, channel controller 235, transceiver interface (IF) 245, radio frequency (RF) transceiver unit 250, antenna array 255, and uplink scheduler 260.

Controller 225 comprises processing circuitry and memory capable of executing an operating program that controls the overall operation of base station 102. In an embodiment, controller 225 may be operable to communicate with network 130. Under normal conditions, controller 225 directs the operation of channel controller 235, which comprises a number of channel elements, such as exemplary channel element 240, each of which performs bidirectional communication in the forward channel and the reverse channel. A forward channel (or downlink) refers to outbound signals from base station 102 to subscriber stations 111-116. A reverse channel (or uplink) refers to inbound signals from subscriber stations 111-116 to base station 102. Channel element 240 also preferably performs all baseband processing, including processing any digitized received signal to extract the information or data bits conveyed in the received signal, typically including demodulation, decoding, and error correction operations, as known to those of skill in the art. Transceiver IF 245 transfers bidirectional channel signals between channel controller 235 and RF transceiver unit 250.

Antenna array 255 transmits forward channel signals received from RF transceiver unit 250 to subscriber stations 111-116 in the coverage area of base station 102. Antenna array 255 is also operable to send to RF transceiver unit 250 reverse channel signals received from subscriber stations 111-116 in the coverage area of the base station 102. According to one embodiment of the present disclosure, antenna array 255 comprises a multi-sector antenna, such as a three-sector antenna in which each antenna sector is responsible for transmitting and receiving in a coverage area corresponding to an arc of approximately 120 degrees. Additionally, RF transceiver unit 250 may comprise an antenna selection unit to select among different antennas in antenna array 255 during both transmit and receive operations.

Uplink scheduler 260 comprises classifier 265, selector 270 and slot allocator 275 and is operable to schedule uplink communications at the best possible data rate for each subscriber station 111-116 based on a traffic type for the subscriber station 111-116, a classification of the subscriber station 111-116, and channel quality. Although illustrated and described as three separate components, it will be understood that any two or more of classifier 265, selector 270 and slot allocator 275 may be implemented together in a single component without departing from the scope of the present disclosure.

Classifier 265 is operable to classify each subscriber station 111-116 as an exploration user or a utilization user. As used herein, “an exploration user” means a subscriber station 111-116 that has a user status of initially active or that has been transmitting on a sub-channel with a change in channel quality that is above a predetermined exploration threshold. In addition, “a utilization user” means a subscriber station 111-116 that has a user status of continuing active and that is transmitting on a sub-channel with a change in channel quality that is below the exploration threshold. Classifier 265 is also operable to provide the classifications of subscriber stations 111-116 to selector 270 and slot allocator 275.

Selector 270 is coupled to classifier 265 and is operable to select at least a subset of the subscriber stations 111-116 for slot allocation based on the classifications of subscriber stations 111-116 provided by classifier 265 and based on a traffic type for the subscriber stations 111-116. Selector is also operable to assign a number of slots to each selected subscriber station 111-116 and to provide the selections and assignments to slot allocator 275. The slots comprise time-frequency slots available for communication between base station 102 and subscriber stations 111-116.

For one embodiment, each subscriber station 111-116 may have an associated traffic type of constant or variable. For a particular embodiment, the constant traffic type subscriber stations 111-116 comprise subscriber stations 111-116 requesting Unsolicited Grant Service, which provides for fixed-size packets on a periodic basis for services such as VoIP, T1, other voice services, and the like, and the variable traffic type subscriber stations 111-116 comprise subscriber stations 111-116 requesting Best Effort service, which provides for non-real-time, variable-size traffic without any Quality-of-Service (QoS) guarantees for data services and the like.

For one embodiment, selector 270 is operable to select the subscriber stations 111-116 for slot allocation by first selecting each of the constant traffic type users and assigning the requested number of slots to each and then selecting from the variable traffic type users and assigning a number of slots to each based on proportional fairness.

For a particular embodiment, selector 270 may select from the variable traffic type users based on the following formula:
k=arg{max[V(k,nₘₐₓ)/R(k)]},
where V(k,nₘₐₓ)=f(q(k,nₘₐₓ,t)) is the maximum supportable rate for the k^{th} user on its best (nₘₐₓ) sub-channel, R(k) is the average rate of the k^{th} user and f ( ) is a given function or look-up table for converting channel quality information, such as C/I values, into data rates. If q(k,nₘₐₓ,t) is unknown, then selector 270 uses the minimum data rate. Using the above formula, selector 270 may select the k^{th} utilization user to be assigned bₖ/f(q(k,n,t)) slots on the n^{th} sub-channel and the k^{th} exploration user to be assigned bₖ/kₘᵢₙ slots.

Slot allocator 275 is coupled to classifier 265 and selector 270 and is operable to allocate, or schedule, slots for subscriber stations 111-116 for communication with base station 102 on the uplink based on the classifications provided by classifier 265 and based on the selections and assignments provided by selector 270. For one embodiment, slot allocator 275 is operable to schedule the slots by scheduling the constant traffic type users followed by the variable traffic type users. Within each of these groups, slot allocator 275 is operable to schedule the utilization users first, followed by the exploration users. Thus, for this embodiment, slot allocator 275 is operable to schedule the constant traffic type, utilization users, followed by the constant traffic type, exploration users, followed by the variable traffic type, utilization users, followed finally by the variable traffic type, exploration users.

Slot allocator 275 is operable to schedule slots for the utilization users horizontally and to schedule slots for the exploration users vertically. As used herein, “to schedule slots horizontally” means that the users are allocated time-frequency slots over multiple time periods within the same frequency band and “to schedule slots vertically” means that the users are allocated time-frequency slots over the same or different time periods within different frequency bands.

Slot allocator 275 is also operable to schedule each group of users based on a priority for the users. For example, while scheduling the constant traffic type, utilization users, slot allocator 275 schedules the constant traffic type, utilization user with the highest priority first and the constant traffic type, utilization user with the lowest priority last.

If all the time-frequency slots for a particular sub-channel have been allocated and if that sub-channel is the optimum sub-channel for a utilization user yet to be scheduled, slot allocator 275 may schedule the utilization user on its next best sub-channel. In addition, if some slots remain for the optimum sub-channel but not enough to fulfill the assigned number of slots, slot allocator 275 may allocate a portion of the assigned slots to the optimum sub-channel and the remaining portion to a next best sub-channel.

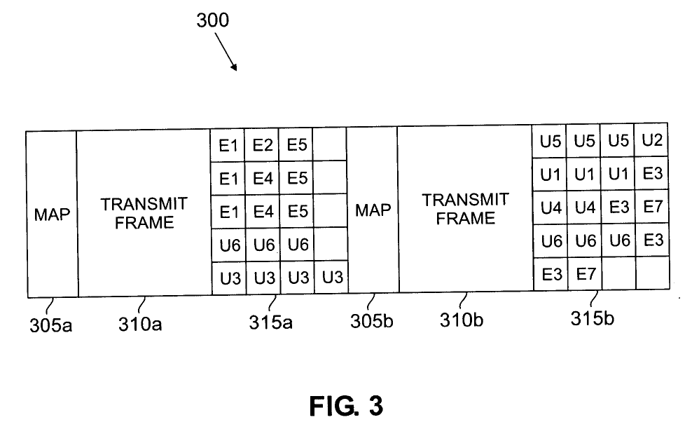

FIG. 3 illustrates an example of uplink scheduling provided by base station 102 according to an embodiment of the present disclosure. Uplink scheduling is illustrated within a set of two frames 300 for communication between base station 102 and subscriber stations 111-116.

Initially, base station 102 transmits a map 305 for each frame, followed by transmit data in the transmit frame 310. Base station 102 then receives data from subscriber stations 111-116 in a receive frame 315. Map 305 comprises scheduling information to inform subscriber stations 111-116 of the time-frequency slots that have been scheduled for them to communicate with base station 102 on the uplink during the following receive frame 315.

Receive frame 315 comprises a plurality of time periods, illustrated horizontally, and a plurality of frequency bands, illustrated vertically, that intersect to form a plurality of time-frequency slots, each of which may be allocated to particular subscriber stations 111-116 for communication. It will be understood that the illustrated receive frames 315a-b are simplified versions of actual receive frames and that any suitable number of time periods, frequency bands, and users may be included in receive frames 315a-b.

Seven subscriber stations 111-116, or users, are illustrated as being allocated time-frequency slots in receive frames 315a-b. For this example, in the first receive frame 315a, users 1, 2, 4 and 5 are exploration users (E1, E2, E4 and E5) and users 3 and 6 are utilization users (U3 and U6). Thus, slot allocator 275 will have allocated users 3 and 6 first (assuming these users are the same traffic type) to their optimum sub-channels, or frequency bands. It will be understood that, if users 3 and 6 have the same optimum sub-channel, slot allocator 275 will have allocated the higher priority user to the optimum sub-channel and the lower priority user to its next best sub-channel. Slot allocator 275 will then have allocated the exploration users to a number of different sub-channels in order to allow base station 102 to determine which of these sub-channels is better for each exploration user.

Continuing with this example, in the second receive frame 315b, users 1, 2, 4, 5 and 6 are utilization users (U1, U2, U4, U5 and U6) and users 3 and 7 are exploration users (E3 and E7). Thus, users 1, 2, 4 and 5, which were exploration users in the first receive frame 315a, have found optimum sub-channels and become utilization users. User 3, on the other hand, which was a utilization user, has experienced a decline in channel quality so that the change in channel quality is larger than the exploration threshold and thus has become an exploration user. User 6, which was a utilization user, has not experienced a significant decline in channel quality and thus has remained a utilization user. User 7 is a new user from the previous frame and, therefore, is an exploration user because user 7 has a user status of initially active.

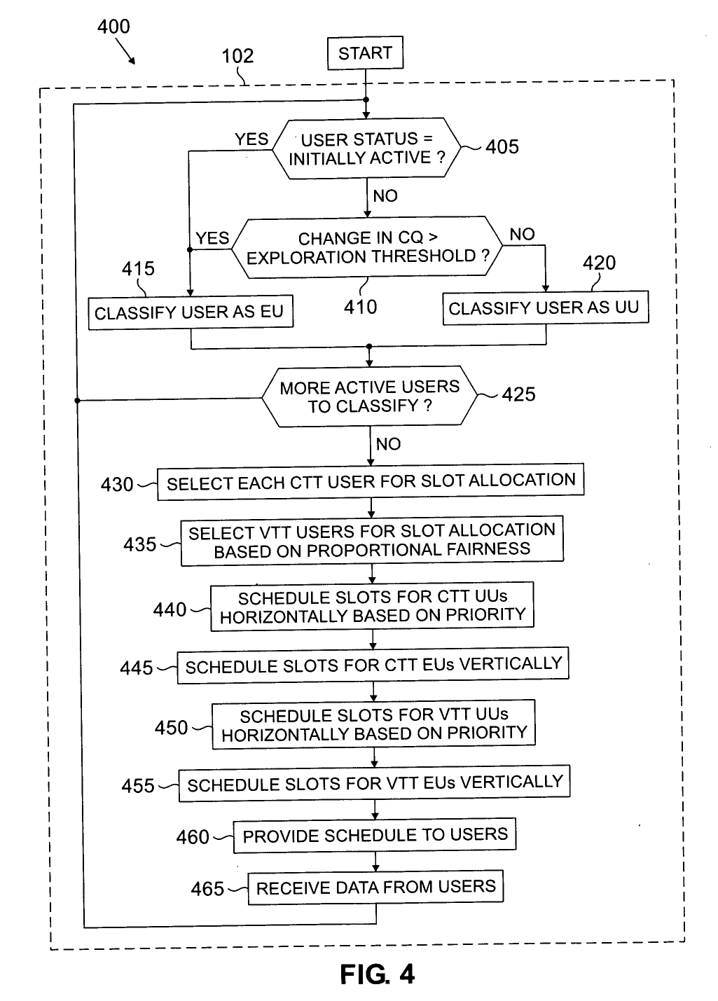

FIG. 4 is a flow diagram illustrating a method 400 for uplink scheduling in base station 102 according to an embodiment of the present disclosure. Although the method is described with respect to base station 102, it will be understood that the method may be performed by any suitable base station in network 100, such as base station 103.

Initially, classifier 265 determines whether the user status for a particular active subscriber station 111-116, or user, is initially active (process step 405). If classifier 265 determines that the user status for the active user is not initially active but is continuing active (process step 405), classifier 265 determines whether a channel quality (CQ) for the sub-channel on which the user is currently communicating has changed more than a predetermined exploration threshold (process step 410).

If classifier 265 determines that the user status for the active user is initially active (process step 405) or that the change in the channel quality is greater than the exploration threshold (process step 410), classifier 265 classifies the user as an exploration user (EU) (process step 415). However, if classifier 265 determines that the channel quality for a continuing active user has not changed more than the exploration threshold (process step 410), classifier 265 classifies the user as a utilization user (UU) (process step 420).

After classifier 265 has classified the user as an exploration user (process step 415) or as a utilization user (process step 420), classifier 265 determines whether or not there are more active users to be classified (process step 425). If there are more active users to be classified (process step 425), classifier 265 determines whether a subsequent active user has a user status of initially active (process step 405) and the method repeats until each active user has been classified.

After classifier 265 has classified each active user (process step 425), selector 270 selects each constant traffic type (CTT) user, whether utilization or exploration, for slot allocation and assigns the requested number of slots for each CTT user (process step 430). Selector 270 then selects from the variable traffic type (VTT) users and assigns a number of slots for each VTT user based on proportional fairness (process step 435).

Slot allocator 275 schedules the assigned number of slots for the CTT utilization users horizontally based on the priority of the users (process step 440). Slot allocator 275 then schedules the assigned number of slots for the CTT exploration users vertically (process step 445). After scheduling the CTT users, slot allocator 275 schedules the assigned number of slots for the VTT utilization users horizontally based on the priority of the users (process step 450). Finally, slot allocator 275 schedules the assigned number of slots for the VTT exploration users vertically (process step 455).

Base station 102 then provides the schedule generated by slot allocator 275 to the subscriber stations 111-116, or users, through a map 305 transmitted prior to a transmit frame 310 (process step 460). During the following receive frame 315, base station 102 receives data from the users according to the schedule provided in map 305 (process step 465), after which the method returns to process step 405 and may repeat for the following frame. For an alternative embodiment, however, the method may be repeated after any suitable number of frames. For this embodiment, the same schedule may be used by subscriber stations 111-116 in following frames until a new schedule is later generated.

In this way, OFDMA network 100, which has sub-channels that experience different fading levels and thus different channel quality, may estimate channel quality on different sub-channels for each subscriber station 111-116 by periodically sending pilot signals on the different sub-channels. This additional information may be used by uplink scheduler 260 to schedule the subscriber stations 111-116 on sub-channels with good channel conditions. In addition, this method allows uplink scheduler 260 to determine the channel qualities and then optimize the uplink spectral efficiency based on those channel qualities. Furthermore, uplink scheduler 260 is able to schedule subscriber stations 111-116 that have different QoS requirements, as indicated by their traffic types, on frequency-selective channels.

While several embodiments have been provided in the present disclosure, it should be understood that the disclosed systems and methods may be embodied in many other specific forms without departing from the spirit or scope of the present disclosure. The exemplary embodiments disclosed are to be considered as illustrative and not restrictive, and the intention is not to be limited to the details given herein. It is intended that the disclosure encompass all alternate forms within the scope of the appended claims along with their full scope of equivalents.

What is claimed is:

1. A method of uplink scheduling in an Orthogonal Frequency Division Multiple Access (OFDMA) network, comprising:
classifying each of a plurality of users as one of an exploration user and a utilization user; and
scheduling the users based on the classification of each of the users as one of an exploration user and a utilization user.

2. The method as set forth in claim 1, classifying each of the users comprising classifying each of the users based on channel quality information received from each of the users and based on a user status for each of the users.

3. The method as set forth in claim 2, further comprising classifying a first user as an exploration user when the channel quality information received from the first user is less than an exploration threshold.

4. The method as set forth in claim 2, further comprising classifying a first user as an exploration user when the user status for the first user comprises initially active.

5. The method as set forth in claim 2, further comprising classifying a first user as a utilization user when the channel quality information received from the first user is equal to or greater than an exploration threshold and when the user status for the first user comprises continuing active.

6. The method as set forth in claim 1, scheduling the users comprising scheduling the utilization users before scheduling the exploration users.

7. The method as set forth in claim 1, scheduling the users comprising scheduling the users based on a traffic type for each of the users.

8. The method as set forth in claim 7, the traffic types comprising constant and variable, scheduling the users further comprising scheduling the constant traffic type, utilization users horizontally, followed by scheduling the constant traffic type, exploration users vertically, followed by scheduling the variable traffic type, utilization users horizontally, followed by scheduling the variable traffic type, exploration users vertically.

9. A method of uplink scheduling in an Orthogonal Frequency Division Multiplexing (OFDM) network, comprising:
classifying each of a plurality of users as one of an exploration user and a utilization user;
assigning a number of slots to each of the users based on a traffic type for the user; and
scheduling the assigned number of slots to each of the users based on the classification of the user as one of an exploration user and a utilization user and based on the traffic type for the user.

10. The method as set forth in claim 9, the traffic types comprising constant and variable, scheduling the users further comprising scheduling the constant traffic type, utilization users horizontally, followed by scheduling the constant traffic type, exploration users vertically, followed by scheduling the variable traffic type, utilization users horizontally, followed by scheduling the variable traffic type, exploration users vertically.

11. The method as set forth in claim 9, classifying each of the users comprising classifying each of the users based on channel quality information received from each of the users and based on a user status for each of the users.

12. The method as set forth in claim 11, further comprising classifying a first user as an exploration user when the channel quality information received from the first user is less than an exploration threshold.

13. The method as set forth in claim 11, further comprising classifying a first user as an exploration user when the user status for the first user comprises initially active.

14. The method as set forth in claim 11, further comprising classifying a first user as a utilization user when the channel quality information received from the first user is equal to or greater than an exploration threshold and when the user status for the first user comprises continuing active.

15. A base station capable of providing uplink scheduling in an Orthogonal Frequency Division Multiplexing (OFDM) network, comprising:
a classifier operable to classify each of a plurality of users as one of an exploration user and a utilization user;
a selector coupled to the classifier, the selector operable to select at least a portion of the users for slot allocation based on a traffic type for each of the users and to assign a number of slots to each of the selected users; and
a slot allocator coupled to the classifier and to the selector, the slot allocator operable to schedule the users based on the classification of each of the users as one of an exploration user and a utilization user and based on the traffic type for each of the users.

16. The base station as set forth in claim 15, the classifier operable to classify each of the users based on channel quality information received from each of the users and based on a user status for each of the users.

17. The base station as set forth in claim 16, the classifier operable to classify a first user as an exploration user when the channel quality information received from the first user is less than an exploration threshold, to classify a second user as an exploration user when the user status for the second user comprises initially active, and to classify a third user as a utilization user when the channel quality information received from the third user is equal to or greater than the exploration threshold and when the user status for the third user comprises continuing active.

18. The base station as set forth in claim 15, the selector operable to assign a number of slots to each of the selected users based on proportional fairness.

19. The base station as set forth in claim 15, the traffic types comprising constant and variable.

20. The base station as set forth in claim 19, the slot allocator operable to schedule the users by scheduling the constant traffic type, utilization users horizontally, followed by scheduling the constant traffic type, exploration users vertically, followed by scheduling the variable traffic type, utilization users horizontally, followed by scheduling the variable traffic type, exploration users vertically.
